(19) United States
(12) Patent Application Publication
(10) Pub. No.: US 2011/0248624 A1
(43) Pub. Date: Oct. 13, 2011

(54) ILLUMINATING DEVICE AND VEHICLE HEADLAMP

(75) Inventors: Katsuhiko Kishimoto, Osaka-shi (JP); Yuji Yokosawa, Osaka-shi (JP); Yoshitaka Tomomura, Osaka-shi (JP)

(73) Assignee: SHARP KABUSHIKI KAISHA, Osaka-shi (JP)

(21) Appl. No.: 13/081,295

(22) Filed: Apr. 6, 2011

(30) Foreign Application Priority Data
Apr. 7, 2010 (JP) 2010-088731
Mar. 24, 2011 (JP) 2011-066136

(51) Int. Cl. H01J 1/63

(52) U.S. Cl. 313/483

(57) ABSTRACT

A headlamp 1 includes: laser diodes 2 that emit excitation light; and a light emitting part 5 that emits light upon receiving the excitation light emitted from the laser diodes 2, the light emitting part 5 containing a first fluorescent material and a second fluorescent material, the first fluorescent material having its emission spectrum peak in a range of not less than 500 nm but not more than 520 nm, the second fluorescent material having an emission spectrum peak which is different from the emission spectrum peak of the first fluorescent material. In a spectrum of the light emitted from the light emitting part 5, a luminous intensity at the emission spectrum peak of the first fluorescent material is higher than a luminous intensity in an emission spectrum covering a range of not less than 540 nm but not more than 570 nm. This allows the headlamp 1 to emit illumination light which achieves a high visibility of an irradiation target at least in a dark place.

This Nonprovisional application claims priority under 35 U.S.C. §119(a) on Patent Application No. 2010-088731 filed in Japan on Apr. 7, 2010 and Patent Application No. 2011-066136 filed in Japan on Mar. 24, 2011, the entire contents of which are hereby incorporated by reference.

### TECHNICAL FIELD

The present invention relates to an illuminating device including: an excitation light source; and a light emitting part that emits fluorescence responsive to excitation light from the excitation light source. The present invention particularly relates to a vehicle headlamp.

### BACKGROUND ART

Recently, vehicle headlamps have been put to practical use each of which utilizes a white LED (Light Emitting Diode) which is a combination of a blue light emitting diode and a fluorescent material. The adoption of light emitting diodes makes it possible to achieve overwhelmingly longer life of the vehicle headlamps than halogen lamps and HID (High Intensity Discharge) lamps, which are conventional light sources. Furthermore, it is considered that power consumption of the vehicle headlamps can be reduced further lower than the HID lamps in the future.

Patent Literature 1 discloses one example of such vehicle headlamps. The vehicle headlamp disclosed in Patent Literature 1 has a plurality of LED chips which emit rays of light having respective different colors. More specifically, Patent Literature 1 discloses that a blue green LED or a green LED is added to the arrangement in which white light is obtained by combining a blue LED with a fluorescent material. Patent Literature 1 discloses only 530 nm (green) as a specific wavelength of such additional LEDs.

A human senses light at photoreceptor cells in his retinas. The photoreceptor cells encompass cone cells and rod cells, which are different in light sensitivity. A sense of vision in a circumstance under a sufficient amount of light (i.e., in a bright place) is referred to as photopic vision. In the case of the photopic vision, the cone cells function to recognize mainly colors and shapes. On the other hand, a sense of vision in a dark place is referred to as scotopic vision. In the case of the scotopic vision, the rod cells function to recognize mainly the variations of brightness.

The photopic vision has the highest sensitivity to yellow-green light having a wavelength of 555 nm. On the other hand, the scotopic vision has the highest sensitivity to light having a wavelength of 507 nm which is slightly bluish. That is, the photopic vision and the scotopic vision have respective different peak wavelengths of luminosity factors, and the peak wavelength of the luminosity factors of the scotopic vision is shifted toward shorter wavelengths, with respect to that of the photopic vision. This phenomenon is referred to as the Purkinje phenomenon.

Patent Literature 2 discloses a retroreflector which is made in view of the Purkinje phenomenon. The base material of the retroreflector is blue, and the colored transparent layer thereof is yellow green. Accordingly, in bright hours such as daytime and early dusk, the retroreflector appears yellow green corresponding to a high photopic relative luminosity factor. On the other hand, in the darkness of night, the retroreflector appears blue (wavelength of close to 507 nm) corresponding to a high scotopic relative luminosity factor, due to light of a headlamp. Thus, the retroreflector allows proper visual guidance any time day or night.

### CITATION LIST

### Patent Literature 1

Japanese Patent Application Publication, Tokukai, No. 2006-351369 A (Publication Date: Dec. 28, 2006)

### Patent Literature 2

Japanese Patent Application Publication, Tokukai, No. 2004-301977 A (Publication Date: Oct. 28, 2004)

### SUMMARY OF INVENTION

### Technical Problem

In general, conventional illumination light sources such as white LEDs are made on the premise of the photopic vision. In the case of the photopic vision, it is possible to properly distinguish colors. In other words, the photopic vision is a sensory state where colors can be properly distinguished. It is a natural demand that a general illumination device provide brightness to the extent that colors can be distinguished.

The following describes a problem of a conventional white LED. FIG. 9 is a graph showing an emission spectrum of a conventional white LED which is a combination of a blue light emitting diode and a fluorescent material.

The dashed line in the graph of FIG. 9 represents a spectrum of a so-called pseudo white LED which is a combination of a blue LED and a yellow fluorescent material. On the other hand, the spectrum represented by the continuous line is a spectrum of a white LED which has a higher color rendering characteristic than that of the pseudo white LED.

FIG. 9 shows that respective spectrum components of the white LEDs are high in luminous intensity near a green spectrum (555 nm) where a luminosity factor is the highest in the photopic vision. This is because both white LEDs are made on the major premise of the photopic vision.

In the case of a vehicle having a headlamp which employs such a white LED, light of the headlamp is not felt to be very bright at night despite a very high specification value (luminous flux) on a catalog. This problem does not arise in use of a conventional halogen lamp or a conventional HID lamp. As a result of diligent study in view of this, the inventors of the present invention found that conventional white LEDs have such a problem due to a drop of a spectrum component near 510 nm.

In other words, the inventors found that since white LEDs which are made on the premise of use in a bright place such as in a room put a higher priority on brightness and efficiency in the photopic vision, light of such white LEDs cannot be felt to be bright in a dark place such as outdoors at night.

Further, none of the Patent Literatures discloses improving visibility of an object in a bright place.

The vehicle headlamp of Patent Literature 1 emits green or blue green light in the front direction of the vehicle, in addition to white light. It follows that light of the vehicle headlamp differs in color in part. Such an arrangement is not legally allowed in Japan. Therefore, the vehicle headlamp of Patent Literature 1 cannot be realized at least in Japan. Furthermore, Patent Literature 1 does not disclose a wavelength of the green or blue green light. Accordingly, it is unclear whether or not the headlamp of Patent Literature 1 makes it possible to eliminate the drop of the spectrum component near 510 nm.

The present invention was made to solve the problem. An object of the present invention is to provide an illuminating device, and particularly, a vehicle headlamp, which emit illumination light which achieves a high visibility of an irradiation target at least in a dark place.

### Solution to Problem

In order to attain the object, an illuminating device of the present invention includes: an excitation light source that emits excitation light; and a light emitting part that emits light upon receiving the excitation light emitted from the excitation light source, the light emitting part containing a first fluorescent material and a second fluorescent material, the first fluorescent material having its emission spectrum peak in a range from 500 nm to 520 nm, the second fluorescent material having an emission spectrum peak which is different from the emission spectrum peak of the first fluorescent material, in a spectrum of the light emitted from the light emitting part, a luminous intensity at the emission spectrum peak of the first fluorescent material being higher than a luminous intensity in an emission spectrum covering a range from 540 nm to 570 nm.

A human eye senses light at photoreceptor cells in the retina. The photoreceptor cells work differently in bright and dark places. Specifically, in a bright place (photopic vision): yellow green light is felt to be brightest; Red light is also felt to be vivid therein; and on the other hand, blue light is not felt to be very bright. In a dark place (scotopic vision): blue green light, which has a shorter wavelength than the yellow green light, is felt to be brighter than the yellow green light; and red light, which has a long wavelength, is felt to be darkly. This is a phenomenon, referred to as the Purkinje phenomenon, in which a luminosity factor is shifted. In the scotopic vision, a human eye is most sensitive to light having a wavelength of 507 nm.

In view of the Purkinje phenomenon, the inventors of the present invention considered that: in nighttime, the vision of a human eye is the scotopic vision, and therefore, by illuminating a road ahead with light containing a broad blue-green spectrum, a person in a vehicle can see an object (obstruction) on the road more clearly. In other words, in nighttime in which the vision of a viewer is the scotopic vision, a luminance of a light source, which is typified by a light flux (lumen) which is usually evaluated for the photopic vision, does not always match a sensory luminance that the viewer senses (i.e., the viewer does not feel that the light is bright), even if the luminance of the light source is high. Note that “can see an object more clearly” means that distinguishability of the object or of the shape (silhouette) of the object is improved. Therefore, it is not essential that the color of the object can be vividly recognized.

Furthermore, the inventors of the present invention considered that not only in a dark place but also in a bright place, irradiation of light containing a broad blue-green spectrum stimulates rod cells so that distinguishability of the shape of an object is improved.

According to the arrangement, the light emitting part emits light upon receiving the excitation light emitted from the excitation light source. Thus, the illumination light is obtained. The light emitting part contains the first and second fluorescent materials. Since the emission spectrum peak of the first fluorescent material is not less than 500 nm but not more than 520 nm, the light emitted from the light emitting part has at least one peak in the range.

Further, in the spectrum of the light emitted from the light emitting part, a luminous intensity at the emission spectrum peak of the first fluorescent material is higher than a luminous intensity in an emission spectrum covering a range of not less than 540 nm but not more than 570 nm.

In other words, the luminous intensity at that emission spectrum peak of the first fluorescent material which is located near the peak of the luminosity factor in the scotopic vision is higher than the luminous intensities in the emission spectrum in the range of not less than 540 nm but not more than 570 nm within which range the luminosity factor in the photopic vision is peaked.

This allows the light emitting part to emit light which achieves a high luminosity factor in the scotopic vision. As a result, it is possible to improve visibility of an object irradiated by the illuminating device in a dark place.

It is considered that irradiation of light having a wavelength in the range of not less than 500 nm but not more than 520 nm stimulates rod cells which are involved in recognition of the shape of an object so that visibility of an object is improved in a bright place. Therefore, the technical scope of the present invention encompasses not only illuminating devices which are used in a dark place, but also the aforementioned illuminating device which is used in a bright place. However, the present invention is not limited to illuminating devices which make it possible to improve visibility of an object both in a dark place and a bright place. That is, the illuminating device of the present invention makes it possible to improve at least visibility of an object in a dark place.

### Advantageous Effects of Invention

As described above, the illuminating device of the present invention includes an excitation light source that emits excitation light; and a light emitting part that emits light upon receiving the excitation light emitted from the excitation light source, the light emitting part containing a first fluorescent material and a second fluorescent material, the first fluorescent material having its emission spectrum peak in a range of not less than 500 nm but not more than 520 nm, the second fluorescent material having an emission spectrum peak which is different from the emission spectrum peak of the first fluorescent material, in a spectrum of the light emitted from the light emitting part, a luminous intensity at the emission spectrum peak of the first fluorescent material being higher than a luminous intensity in an emission spectrum covering a range of not less than 540 nm but not more than 570 nm.

This makes it possible to emit light which achieves a high luminosity factor in the scotopic vision, and to improve visibility of an object irradiated by the illuminating device at least in a dark place.

### BRIEF DESCRIPTION OF DRAWINGS

FIG. 1

FIG. 1 is a cross-sectional view schematically illustrating an arrangement of a headlamp of one embodiment of the present invention.

FIG. 2

(a) of FIG. 2 is a view schematically illustrating circuitry of a laser diode. (b) of FIG. 2 is a perspective view illustrating a fundamental structure of the laser diode 2.

FIG. 3

FIG. 3 is a view showing properties of Caα-SiAlON:Ce³⁺ fluorescent material and CaAlSiN₃:Eu²⁺ fluorescent material.

FIG. 4

FIG. 4 is a graph showing a chromaticity range of white colors required for vehicle headlamps.

FIG. 5

FIG. 5 is a graph showing an emission spectrum of a light emitting part of the one embodiment of the present invention.

FIG. 6

FIG. 6 is a graph showing an emission spectrum of a light emitting part of another embodiment of the present invention.

FIG. 7

FIG. 7 is a cross-sectional view schematically illustrating an arrangement of a headlamp of another embodiment of the present invention.

FIG. 8

FIG. 8 is a view illustrating positional relation between exit end parts of optical fiber and the light emitting part.

FIG. 9

FIG. 9 is a graph showing an emission spectrum of a conventional white LED which is a combination of a blue light emitting diode and a fluorescent material.

### DESCRIPTION OF EMBODIMENTS

### Embodiment 1

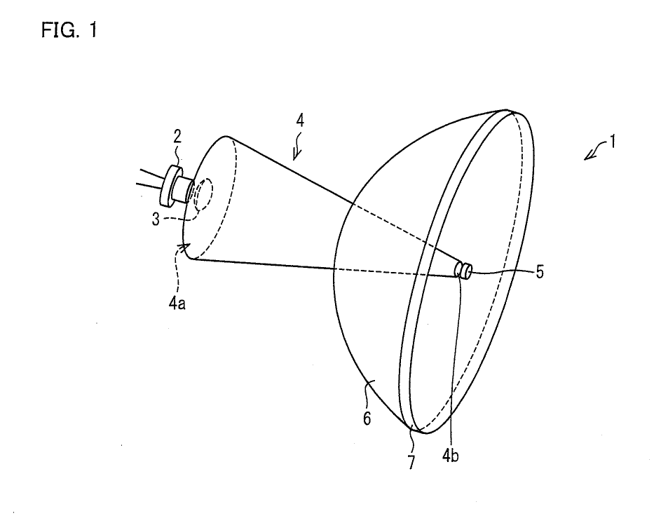

The following describes one embodiment of the present invention, with reference to FIGS. 1 to 3.

(Technical Idea of Present Invention)

In view of the Purkinje phenomenon, the inventors of the present invention considered that: in nighttime, the vision of a human eye is the scotopic vision, and therefore, by illuminating a road ahead with light containing a broad blue-green spectrum, a person in a vehicle can see an object (obstruction) on the road more clearly. In other words, in nighttime in which the vision of a viewer is the scotopic vision, a luminance of a light source, which is typified by a light flux (lumen) which is usually evaluated for the photopic vision, does not always match a sensory luminance that the viewer senses (i.e., the viewer does not feel that the light is bright), even if the luminance of the light source is high. Note that “can see an object more clearly” means that distinguishability of the object or of the shape (silhouette) of the object is improved. Therefore, it is not essential that the color of the object can be vividly recognized.

Furthermore, the inventors of the present invention considered that not only in a dark place but also in a bright place, irradiation of light containing a broad blue-green spectrum stimulates rod cells so that distinguishability of the shape of an object is improved.

The illuminating device of the present invention was made based on the technical idea. By emitting light whose luminosity factor is high under circumstances where human vision is the scotopic vision, the illuminating device makes it possible to improve visibility of an object in a dark place (e.g., in night driving). Further, in some cases, the illuminating device of the present invention makes it possible to improve visibility of an object not only in a dark place but also in a bright place. That is, the illuminating device of the present invention makes it possible to improve at least visibility of an object in a dark place.

The present embodiment describes, as one example of the illuminating device of the present invention, a headlamp (vehicle headlamp) 1 which satisfies light distribution property standards for driving headlamps (i.e., high beam) for automobiles. Note that the illuminating device of the present invention may be realized as a headlamp for a vehicle except automobiles or for a moving object except automobiles (e.g., a human, a vessel, an airplane, a submersible vessel, or a rocket), or may be realized as another illuminating device such as a searchlight.

(Arrangement of Headlamp 1)

The following describes an arrangement of the headlamp (illuminating device) 1 of the present embodiment, with reference to FIG. 1. FIG. 1 is a view schematically illustrating an arrangement of the headlamp 1 of the present embodiment. As illustrated in FIG. 1, the headlamp 1 includes laser diodes 2, aspheric lenses 3, a light guide section 4, a light emitting part 5, a reflection mirror 6, and a transparent plate 7.

(Laser Diode 2)

The laser diodes 2 function as an excitation light sources which emit excitation light. The laser diodes 2 may be a single laser diode 2 or a plurality of laser diodes 2. Further, each of the laser diodes 2 may be one such that one luminous point is provided on one chip, or may be one such that a plurality of luminous points are provided on one chip. The present embodiment deals with the laser diodes 2 in each of which one luminous point is provided on one chip.

Each of the laser diodes 2 is arranged such that e.g.: one luminous point (one stripe) is provided on one chip; each of the laser diodes 2 emits a laser beam at a wavelength of 405 nm (bluish purple); an optical output is 1.0 W; an operating voltage is 5 V; and an operating current is 0.7 A. Each of the laser diodes 2 is sealed in a package (stem) that is 5.6 mm in diameter. Since 10 laser diodes 2 are used in the present embodiment, a total optical output is 10 W. For convenience, FIG. 1 illustrates only one laser diode 2.

A wavelength of a laser beam which is emitted from each of the laser diodes 2 is not limited to 405 nm. That is, a peak wavelength of the laser beam is in a wavelength range of not less than 400 nm but not more than 460 nm, more preferably, in a wavelength range of not less than 400 nm but not more than 420 nm.

By adopting, as a wavelength of the laser diodes 2, a wavelength which has a peak wavelength in the wavelength range of not less than 400 nm but not more than 420 nm, it becomes possible to expand the range of options to choose a second fluorescent material which is combined with a first fluorescent material (its emission peak wavelength is in a range of not less than 500 nm but not more than 520 nm) so that the light emitting part 5 for emitting white light is made. Specifically, it becomes possible to adopt, as the second fluorescent material, a fluorescent material having an emission spectrum peak in a range of not less than 600 nm but not more than 680 nm.

In a case where the fluorescent materials of the light emitting part 5 is an oxynitride fluorescent material, it is preferable that an optical output of each of the laser diodes 2 be in a range of not less than 1 W but not more than 20 W, and a light density of a laser beam which is incident on the light emitting part 5 be in a range of not less than 0.1 W/mm² but not more than 50 W/mm². Such an optical output makes it possible to achieve a luminous flux and a luminance which are required for a vehicle headlamp, and to prevent extreme deterioration of the light emitting part 5 due to a high-power laser beam. In other words, such an optical output makes it possible to realize a longer life of a light source despite a high luminous flux and a high luminance.

Note that, in a case where a semiconductor nanoparticle fluorescent material is adopted as the fluorescent materials of the light emitting part 5, a light density of the laser beam which is incident on the light emitting part 5 may be higher than 50 W/mm².

(Aspheric Lenses 3)

The aspheric lenses 3 are lenses for guiding laser beams emitted from the laser diodes 2 so that the laser beams enter the light guide section 4 via a light receiving surface 4a which is one of two end surfaces of the light guide section 4. Examples of the aspheric lenses 3 encompass FLKN1 405 manufactured by Alps Electric Co., Ltd. A shape and a material of the aspheric lenses 3 are not particularly limited, provided that the aforementioned function is achieved. A material of the aspheric lenses 3 preferably has a high transmittance near 405 nm and a high heat resistance.

The aspheric lenses 3 are for converging the laser beams emitted from the laser diodes 2 so as to guide the laser beams to a relatively small (e.g., diameter of not more than 1 mm) light receiving surface. Therefore, in a case where the light receiving surface 4a of the light guide section 4 is large to the extent that there is no need to converge the laser beams, there is no need to provide the aspheric lenses 3.

(Light Guide Section 4)

The light guide section 4 is a light guide having a shape of a truncated cone. The light guide section 4 converges the laser beams emitted from the laser diodes 2 so as to guide the laser beams to the light emitting part 5 (i.e., a laser beam-irradiated surface of the light emitting part 5). The light guide section 4 is optically combined with the laser diodes 2 via the aspheric lenses 3 (or directly). The light guide section 4 has: the light receiving surface 4a (entrance end part) for receiving the laser beams emitted from the laser diodes 2; and a light emitting surface 4b (exit end part) for emitting, toward the light emitting part 5, the laser beams received on the light receiving surface 4a.

The light emitting surface 4b has a smaller area than that of the light receiving surface 4a. Accordingly, the laser beams which have entered the light guide section 4 via the light receiving surface 4a are converged by traveling to the light emitting surface 4b while being reflected on a side surface of the light guide section 4. In this way, the laser beams thus converged are emitted via the light emitting surface 4b.

The light guide section 4 is made from BK7, fused quartz, acrylic resin, or another transparent material. The light receiving surface 4a and the light emitting surface 4b may be a flat surface or a curved surface.

The light guide section 4 may have a shape of a truncated pyramid, and may be an optical fiber, provided that the light guide section 4 guides the laser beams from the laser diodes 2 to the light emitting part 5. Alternatively, it may be arranged such that the light guide section 4 is not provided but the light emitting part 5 is irradiated with the laser beams from the laser diodes 2 directly or via the aspheric lenses 3. Such an arrangement is possible in a case where a distance between the laser diodes 2 and the light emitting part 5 is small.

(Composition of Light Emitting Part 5)

The light emitting part 5 emits light in response to the laser beams emitted via the light emitting surface 4b of the light guide section 4. Specifically, the light emitting part 5 is such that a plurality of fluorescent materials which emit light in response to a laser beam are dispersed in a fluorescent material-holding substance (sealing material). More specifically, the light emitting part 5 contains a first fluorescent material and a second fluorescent material having an emission spectrum peak which is different from that of the first fluorescent material. The first fluorescent material has an emission spectrum peak near 507 nm which is a peak wavelength of the luminosity factor in the photopic vision. More specifically, the first fluorescent material has an emission spectrum peak in a range of not less than 500 nm but not more than 520 nm. On the other hand, the second fluorescent material has an emission spectrum peak in a range of, e.g., not less than 600 nm but not more than 680 nm.

The composition of the light emitting part 5 is adjusted so that in a spectrum of light which is emitted from the light emitting part 5, a luminous intensity at the emission spectrum peak of the first fluorescent material is higher than luminous intensities in an emission spectrum covering a range of not less than 540 nm but not more than 570 nm.

Each of the first and second fluorescent materials is an oxynitride fluorescent material, or a semiconductor nanoparticle fluorescent material which contains nanometer-size particles of a III-V group compound semiconductor.

A so-called sialon (SiAlON (silicon aluminum oxynitride)) fluorescent material can be adopted as the oxynitride fluorescent material. The sialon fluorescent material is silicon nitride in which (i) one or more of silicon atoms are substituted by an aluminum atom(s) and (ii) one or more of nitrogen atoms are substituted by an oxygen atom(s). The sialon fluorescent material can be produced by solidifying alumina (Al₂O₃), silica (SiO₂), a rare-earth element, and/or the like with silicon nitride (Si₃N₄). The first fluorescent material is, e.g., Caα-SiAlON:Ce³⁺ fluorescent material. On the other hand, the second fluorescent material is, e.g., CaAlSiN₃:Eu²⁺ fluorescent material.

The semiconductor nanoparticle fluorescent material is characterized in that even if the nanoparticles are made of an identical compound semiconductor (e.g., indium phosphorus: InP), it is possible to cause the nanoparticles to emit light of different colors by changing particle size thereof to a nanometer size. The change in color occurs due to a quantum size effect. For example, in the case where the semiconductor nanoparticle fluorescent material is made of InP, the semiconductor nanoparticle fluorescent material emits red light when each of the nanoparticles is approximately 3 nm to 4 nm in diameter. The particle size is evaluated with use of a transmission electron microscope [TEM].

Further, the semiconductor nanoparticle fluorescent material is a semiconductor-based material, and therefore the life of the fluorescence is short. Accordingly, the semiconductor nanoparticle fluorescent material can quickly convert power of the excitation light into fluorescence, and therefore is highly resistant to high-power excitation light. This is because the emission life of the semiconductor nanoparticle fluorescent material is approximately 10 nanoseconds, which is some five digits less than a commonly used fluorescent material that contains rare earth as a luminescence center.

In addition, since the emission life is short as described above, it is possible to quickly repeat absorption of a laser beam and emission of fluorescence. Accordingly, it is possible to maintain high conversion efficiency with respect to intense laser beams, thereby reducing heat emission from the fluorescent materials. This makes it possible to further prevent a heat deterioration (discoloration and/or deformation) in the light emitting part 5. This achieves a longer life of the headlamp 1.

The sealing material may be a resin such as silicon resin, or may be a glass material (e.g., inorganic glass and organic hybrid glass). The light emitting part 5 may be made by ramming the fluorescent materials only. However, the light emitting part 5 is preferably such that the fluorescent materials are dispersed in the sealing material. This is because deterioration of the light emitting part 5 due to laser irradiation is accelerated in a case where the light emitting part 5 is made by ramming the fluorescent materials only.

(Disposition and Shape of Light Emitting Part 5)

The light emitting part 5 is fixed in a focal point of the reflection mirror 6 or in the vicinity thereof, on an inner surface (on a light emitting surface 4b side) of the transparent plate 7. A method of fixing a position of the light emitting part 5 is not limited to this, and therefore the light emitting part 5 may be fixed by using a bar-shaped or tubular member extending from the reflection mirror 6.

A shape of the light emitting part 5 is not particularly limited, but may be a rectangular parallelepiped or a cylinder. In the present embodiment, the light emitting part 5 is a cylindrical column, which is 3 mm in diameter and 3 mm in thickness (height). The laser beam-irradiated surface, which is a surface of the light emitting part 5 to be irradiated with a laser beam, is not necessarily required to be a flat surface but may be a curved surface. However, in order to control reflection of a laser beam, it is preferable that the laser beam-irradiated surface be a flat surface. In a case where the laser beam-irradiated surface is a curved surface, at least an incident angle to the curved surface is significantly different from that of the flat surface. This significantly changes a traveling direction of the reflected light, depending on a position irradiated with the laser beam. As a result, the control of the reflection function of the laser beam can be difficult. In contrast, in a case where the laser beam-irradiated surface is a flat surface, the traveling direction of the reflected light is hardly changed even if a position to be irradiated with the laser beam is somewhat shifted. Therefore, it is easy to control the reflection direction. In some cases, it is easy to put an absorber to absorb the laser beam in a position to be irradiated with the reflected light.

Further, the light emitting part 5 is not necessarily required to have a thickness of 3 mm. The light emitting part 5 has a thickness such that the laser beams are wholly converted into white light by the light emitting part 5 or such that the laser beams are sufficiently scattered by the light emitting part 5. In other words, the light emitting part 5 has a thickness such that an intensity of coherent light harmful to human health is decreased to a safe level, or such that the coherent light is converted into harmless incoherent light.

A required thickness of the light emitting part 5 varies depending on a ratio between the sealing material and the fluorescent materials in the light emitting part 5. A higher content of the fluorescent materials in the light emitting part 5 makes it possible to adopt a smaller thickness of the light emitting part 5 because the higher content of the fluorescent materials in the light emitting part 5, the higher efficiency in the conversion of the laser beams into the white light.

(Reflection Mirror 6)

The reflection mirror 6 reflects incoherent light emitted from the light emitting part 5, thereby forming a bundle of beams reflected at predetermined solid angles. That is, the reflection mirror 6 reflects light emitted from the light emitting part 5, thereby forming a bundle of beams traveling in a forward direction from the headlamp 1. The reflection mirror 6 is for example a member having a curved surface (cup shape), whose surface is coated with a metal thin film. The reflection mirror 6 has an opening, which opens toward a direction in which the reflected light travels.

The reflection mirror 6 is not limited to a hemispherical mirror, but may be an ellipsoidal mirror, a parabolic mirror, or a mirror having a part of such a curved surface. That is, the reflection surface of the reflection mirror 6 contains at least a part a curved surface which is formed in such a manner that a figure (an ellipse, a circle, or a parabola) is rotated around a rotation axis.

(Transparent Plate 7)

The transparent plate 7 is a transparent resin plate that covers the opening of the reflection mirror 6 and holds the light emitting part 5. The transparent plate 7 is preferably made from a material that (i) blocks laser beams emitted from the laser diodes 2 and (ii) transmits white light (incoherent light) into which the light emitting part 5 converts the laser beams. The transparent plate 7 is not limited to the resin plate but may be an inorganic glass plate or the like.

The light emitting part 5 converts most of a coherent laser beam into incoherent white light. Note however that, part of the laser beam may not be converted for some reasons. Even so, since the transparent plate 7 blocks the laser beams, it is possible to prevent the laser beams from leaking out. Note here that, in a case where (a) such an effect is not necessary and (b) the light emitting part 5 is held by a member other than the transparent plate 7, the transparent plate 7 may be omitted.

(Arrangement of Laser Diodes 2)

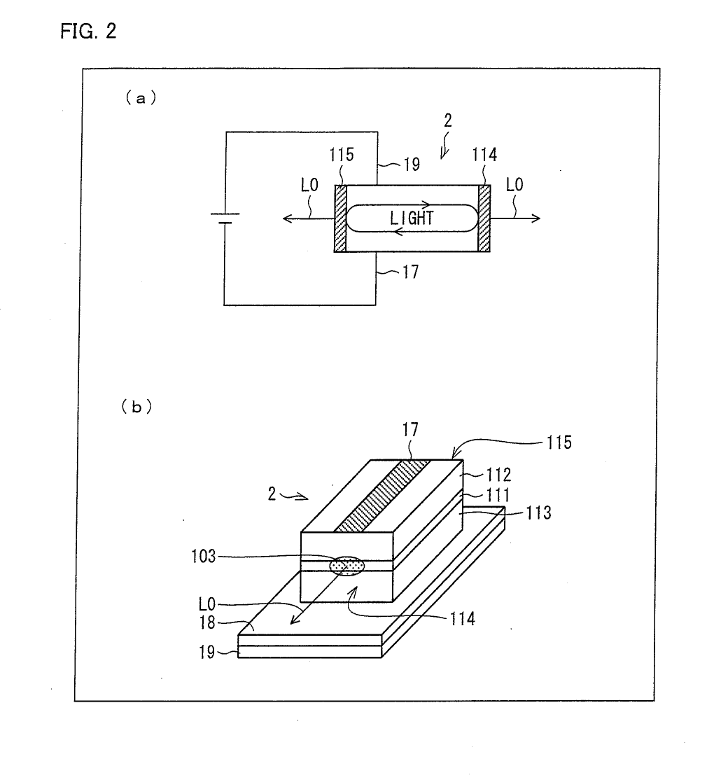

The following description discusses a fundamental structure of each of the laser diodes 2. (a) of FIG. 2 is a circuit diagram schematically illustrating a circuit of a laser diode 2. (b) of FIG. 2 is a perspective view illustrating a fundamental structure of the laser diode 2. As illustrated in (b) of FIG. 2, the laser diode 2 includes: a cathode electrode 19, a substrate 18, a clad layer 113, an active layer 111, a clad layer 112, and an anode electrode 17, which are stacked in this order.

The substrate 18 is a semiconductor substrate. In order to obtain excitation light such as from blue excitation light to ultraviolet excitation light so as to excite a fluorescent material as in the present invention, it is preferable that the substrate 18 be made of GaN, sapphire, and/or SiC. Generally, for example, a substrate for the laser diode is constituted by: a IV group semiconductor such as that made of Si, Ge, or SiC; a III-V group compound semiconductor such as that made of GaAs, GaP, InP, AlAs, GaN, InN, InSb, GaSb, or AlN; a II-VI group compound semiconductor such as that made of ZnTe, ZeSe, ZnS, or ZnO; oxide insulator such as ZnO, Al₂O₃, SiO₂, TiO₂, CrO₂, or CeO₂; or nitride insulator such as SiN.

The anode electrode 17 injects an electric current into the active layer 111 via the clad layer 112.

The cathode electrode 19 injects, from a bottom of the substrate 18 and via the clad layer 113, an electric current into the active layer 111. The electrical current is injected by applying forward bias to the anode electrode 17 and the cathode electrode 19.

The active layer 111 is sandwiched between the clad layer 113 and the clad layer 112.

Each of the active layer 111 and the clad layers 112 and 113 is constituted by, so as to obtain excitation light such as from blue excitation light to ultraviolet excitation light, a mixed crystal semiconductor made of AlInGaN. Generally, each of an active layer and clad layer of the laser diode is constituted by a mixed crystal semiconductor, which contains as a main composition Al, Ga, In, As, P, N, and/or Sb. The active layer and clad layers in accordance with the present invention can also be constituted by such a mixed crystal semiconductor. Alternatively, the active layer and clad layers can be constituted by a II-VI group compound semiconductor such as that made of Zn, Mg, S, Se, Te, or ZnO.

The active layer 111 emits light upon injection of the electric current. The light emitted from the active layer 111 is kept within the active layer 111, due to a difference in refractive indices of the clad layer 112 and the clad layer 113.

The active layer 111 further has a front cleavage surface 114 and a back cleavage surface 115, which face each other so as to keep, within the active layer 111, light that is enhanced by induced emission. The front cleavage surface 114 and the back cleavage surface 115 serve as mirrors.

Note however that, unlike a mirror that reflects light completely, the front cleavage surface 114 and the back cleavage surface 115 (for convenience of description, these are collectively referred to as the front cleavage surface 114 in the present embodiment) of the active layer 111 transmits part of the light enhanced due to induced emission. The light emitted outward from the front cleavage surface 114 is excitation light L0. The active layer 111 can have a multilayer quantum well structure.

The back cleavage surface 115, which faces the front cleavage surface 114, has a reflection film (not illustrated) for laser oscillation. By differentiating reflectance of the front cleavage surface 114 from reflectance of the back cleavage surface 115, it is possible for most of the excitation light L0 to be emitted from a luminous point 103 of an end surface having low reflectance (e.g., the front cleavage surface 114).

Each of the clad layer 113 and the clad layer 112 can be constituted by: a n-type or p-type III-V group compound semiconductor such as that made of GaAs, GaP, InP, AlAs, GaN, InN, InSb, GaSb, or MN; or a n-type or p-type II-VI group compound semiconductor such as that made of ZnTe, ZeSe, ZnS, or ZnO. The electrical current can be injected into the active layer 111 by applying forward bias to the anode electrode 17 and the cathode electrode 19.

A semiconductor layer such as the clad layer 113, the clad layer 112, and the active layer 111 can be formed by a commonly known film formation method such as MOCVD (metalorganic chemical vapor deposition), MBE (molecular beam epitaxy), CVD (chemical vapor deposition), laser-ablation, or sputtering. Each metal layer can be formed by a commonly known film formation method such as vacuum vapor deposition, plating, laser-ablation, or sputtering.

(Principle of Light Emission of Light emitting part 5)

Next, the following description discusses a principle of a fluorescent material emitting light upon irradiation of a laser beam oscillated from the laser diode 2.

First, the fluorescent material contained in the light emitting part 5 is irradiated with the laser beam oscillated from the laser diode 2. Upon irradiation of the laser beam, an energy state of electrons in the fluorescent material is excited from a low energy state into a high energy state (excitation state).

After that, since the excitation state is unstable, the energy state of the electrons in the fluorescent material returns to the low energy state (an energy state of a ground level, or an energy state of an intermediate metastable level between ground and excited levels) after a certain period of time.

As described above, the electrons excited to be in the high energy state returns to the low energy state. In this way, the fluorescent material emits light.

Note here that, white light can be made by mixing three colors which meet the isochromatic principle, or by mixing two colors which are complimentary colors for each other. The white light can be obtained by combining (i) a color of the laser beam oscillated from the laser diode 2 and (ii) a color of the light emitted from the fluorescent material on the basis of the foregoing principle and complementary relationship.

### Example 1

The following describes an example of the light emitting part 5 in more detail. In the present embodiment, employed as the first fluorescent material having an emission spectrum peak in a range of not less than 500 nm but not more than 520 nm is Caα-SiAlON:Ce³⁺ fluorescent material (hereinafter, abbreviated as Caα-SiAlON fluorescent material), and employed as the second fluorescent material having an emission spectrum peak in a range of not less than 620 nm but not more than 680 nm is CASN:Eu (CaAlSiN₃:Eu²⁺) fluorescent material (hereinafter, referred to as CASN fluorescent material).

(Properties of Fluorescent Materials)

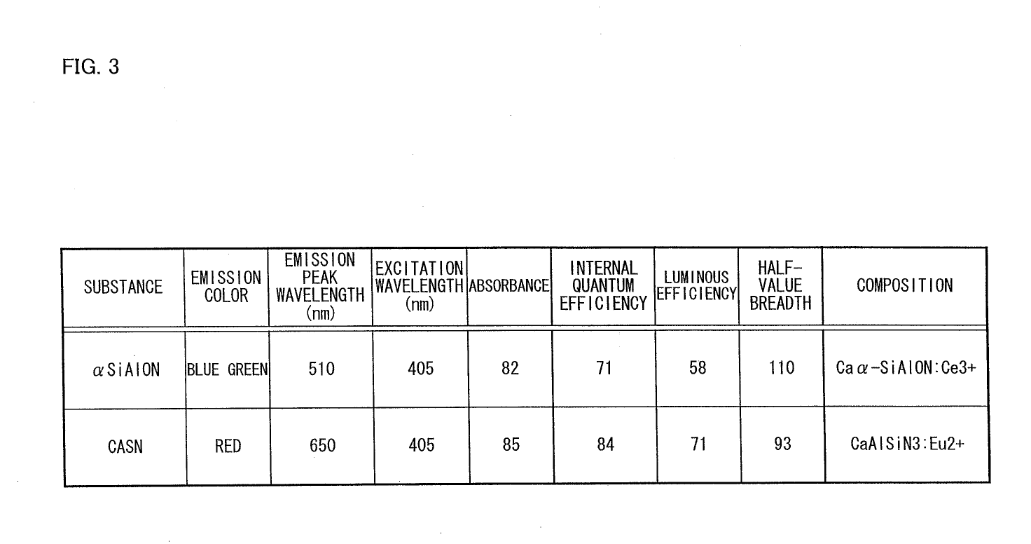

FIG. 3 is a table showing properties of the Caα-SiAlON:Ce³⁺ fluorescent material and the CaAlSiN₃:Eu²⁺ fluorescent material. As shown in the table, the Caα-SiAlON fluorescent material emits fluorescence ranging from blue to green, and its emission peak wavelength is 510 nm. The Caα-SiAlON fluorescent material has an emission half-value breadth of 110 nm, which is broad. Thus, the Caα-SiAlON fluorescent material fully covers wavelengths with high scotopic relative luminosity factors. Further, the Caα-SiAlON fluorescent material has a high luminous efficiency of 58%. Further, the Caα-SiAlON fluorescent material has a high heat resistance. Therefore, the light emitting part 5 is unlikely to become deteriorated even if the light emitting part 5 is irradiated with a high-power laser beam at a high light density. This makes it possible to realize a headlamp with a high luminance and a high luminous flux.

The CASN fluorescent material emits red fluorescent, and its emission peak wavelength is 650 nm. The CASN fluorescent material has a luminous efficiency of 71%, and an emission half-value breadth of 93 nm. The CASN fluorescent material also has a high heat resistance. Therefore, the light emitting part 5 is unlikely to become deteriorated even if the light emitting part 5 is irradiated with a high-power excitation light at a high light density. This makes it possible to realize a headlamp with a high luminance and a high luminous flux.

FIG. 3 shows values obtained in a case where an excitation wavelength was 405 nm. In a case where an excitation wavelength of the Caα-SiAlON fluorescent material increases, an emission peak wavelength thereof increases accordingly. This decreases an absorbance and an internal quantum efficiency. As a result, a luminous efficiency also decreases. In this case, a half-value breadth becomes somewhat wider.

In contrast, in a case where the excitation wavelength decreases, the absorptance, the internal quantum efficiency, and the luminous efficiency somewhat increase up to approximately 350 nm. In this case, an emission peak wavelength decreases somewhat, and a half-value breadth also becomes somewhat narrower. In a case where the excitation wavelength is shorter than 350 nm, the Caα-SiAlON fluorescent material does not emit fluorescent.

In an excitation wavelength range of not less than 350 nm but not more than 450 nm, the CASN fluorescent material has almost constant properties (emission peak wavelength, absorptance, internal quantum efficiency, luminous efficiency, and half-value breadth). The CASN fluorescent material has somewhat undesirable properties in an excitation wavelength range of not shorter than 450 nm. In an excitation wavelength range of not longer than 350 nm, the CASN fluorescent material does not emit fluorescent, as is the case with the Caα-SiAlON fluorescent material.

(Adjustment of White Light)

The light emitting part 5 containing these fluorescent materials was irradiated with the laser beams which were emitted from the laser diodes 2 at an oscillation wavelength of 405 nm, so that illumination light is generated. A ratio between the Caα-SiAlON fluorescent material and the CASN fluorescent material in the light emitting part 5 was adjusted so that a color temperature of the illumination light was in a range of not less than 3000 K but not more than 7000 K, and the illumination light was white light which falls within a range of white colors which are required for headlamps which range is stipulated under the Road Trucking Vehicle Law. The color temperature was adjusted so as to be preferred by many users in the market.

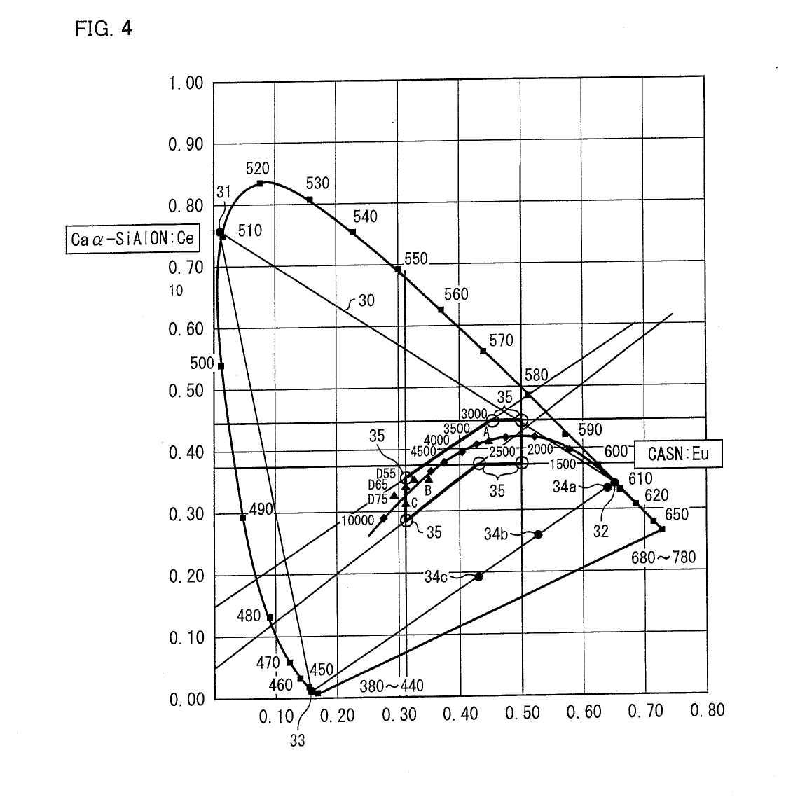

FIG. 4 is a graph showing a chromaticity range of white colors which are required for vehicle headlamps. The chromaticity range is stipulated in Japan by law as shown in FIG. 4. Specifically, the chromaticity range corresponds to the inside of a polygon which has six points 35 as its vertexes.

According to the graph, it is possible to realize chromaticities indicated by points within a triangle 30 which connects a point 31 which indicates an emission peak wavelength of the Caα-SiAlON fluorescent material, a point 32 which indicates an emission peak wavelength of the CASN fluorescent material, and a point 33 which indicates the oscillation wavelength 405 nm of the laser diodes 2 which are excitation light sources. A point which indicates a chromaticity of illumination light which is realized moves within the triangle 30, by changing: a ratio between the Caα-SiAlON fluorescent material and the CASN fluorescent material in the light emitting part 5, a mixing ratio between the sealing material and the fluorescent materials in the light emitting part 5, and an intensity of the excitation light. For example, in a case where a ratio of the Caα-SiAlON fluorescent material is increased, a point indicating a chromaticity of the illumination light approaches the point 31. As a result, the illumination light has a more bluish color.

The triangle 30 contains the polygon. The ratio between the Caα-SiAlON fluorescent material and the CASN fluorescent material in the light emitting part 5, the mixing ratio between the sealing material and the fluorescent materials in the light emitting part 5, and the intensity of the excitation light are determined so that a chromaticity is realized which is indicated by a point within the polygon.

A chromaticity of the illumination light is determined so that a point indicating the chromaticity is within the region defined by the triangle which has points 31, 34a, and 34c as its vertexes, and within the region defined by the polygon which has the points 35 as its vertexes.

The point 34a is a point where a ratio between a radiant flux of the fluorescent from CASN:Eu²⁺ and a radiant flux of the laser beams which are emitted from the laser diodes 2 is 1:0.1. The point 34b is a point where the ratio is 1:1. The point 34c is a point where the ratio is 1:2.5. The laser beams themselves have their own chromaticity. Therefore, by employing a constant composition of the light emitting part 5 and changing the radiant flux of the laser beams, a point indicating the chromaticity of the illumination light moves on a line segment which connects the points 32 and 33.

The ratio between the first and second fluorescent materials varies according to respective luminous efficiencies as well as respective fluorescence colors. An ultimate color of the illumination light varies according also to a color and an intensity of the laser beams and a type and an amount of the sealing material. Therefore, the ratio between the first and second fluorescent materials is adjusted in consideration of these factors.

The present example employed 1:3.6:100 as a ratio of the Caα-SiAlON fluorescent material, the CASN fluorescent material, and silicon resin which serves as the sealing material, so as to form the light emitting part 5 having a diameter and a height of 3 mm. The light emitting part 5 was irradiated with laser beams having a wavelength of 405 nm, in order to measure a spectrum and a chromaticity of obtained illumination light.

As a result, the chromaticity of the illumination light was one indicated by coordinates of x=0.4101 and y=0.4017 in the graph of FIG. 4. The chromaticity satisfies a safety standard in Japan for road trucking vehicles. In other words, the measurement demonstrated that a color of the light emitted from the light emitting part 5 was adjusted to a white color within the legally-stipulated range of colors of light of vehicle headlamps. A color temperature of the illumination light was 3500 K. An average color rendering index Ra was 86.6. A special color rendering index R9 was 57.6.

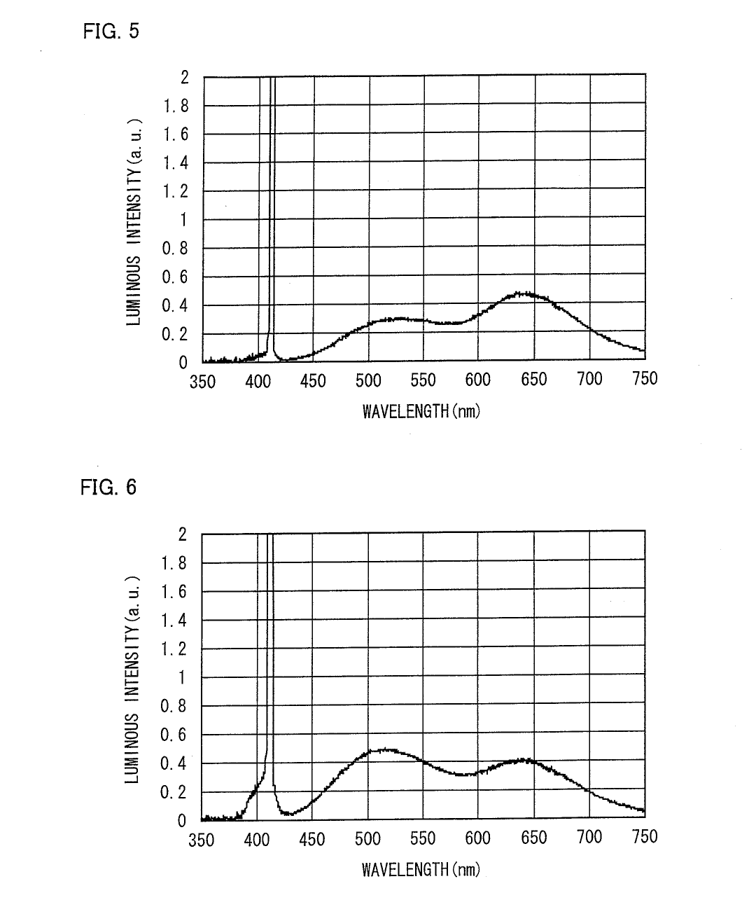

FIG. 5 is a graph showing an emission spectrum of the light emitting part 5 of the present example. An emission spectrum peak of the Caα-SiAlON fluorescent material falls within a wavelength range of not less than 500 nm but not more than 520 nm. The emission spectrum peak locates near a peak of the luminosity factor in the scotopic vision. As shown in FIG. 5, this made it possible to obtain an emission spectrum which has a sufficiently high intensity near 510 nm around which the luminosity factor is peaked in the scotopic vision. In the spectrum of the light emitted from the light emitting part 5, a luminous intensity at the emission spectrum peak of the Caα-SiAlON fluorescent material is higher than luminous intensities in an emission spectrum covering a range of not less than 540 nm but not more than 570 nm. In other words, the luminous intensity at the emission spectrum peak of the Caα-SiAlON fluorescent material which is the first fluorescent material is higher than the luminous intensities in the emission spectrum covering the range of not less than 540 nm but not more than 570 nm within which range the peak of luminosity factors in the photopic vision falls.

As a result, employment of the white light source as a vehicle headlamp makes it possible to realize a vehicle headlamp which excels in obstruction visibility in night driving in which human vision is the scotopic vision.

Further, in a bright place, irradiation of light having a wavelength in the range of not less than 500 nm but not more than 520 nm (particularly, light having a wavelength close to 507 nm) stimulates rod cells which are involved in recognition of the shape of an object so that visibility of an object is improved. Therefore, even if vision is not the scotopic vision totally, this makes it possible to realize a headlamp which excels in obstruction visibility in a case where vision lies between the scotopic vision and the photopic vision.

The peak near 510 nm was very broad. This makes it possible to realize a vehicle headlamp whose brightness cannot be felt by a user to be discontinuous in a case where a luminosity factor varies from early evening (photopic vision) in which dim light still remains to dark night (scotopic vision).

Further, the white light source has an excellent average color rendering index of 86.6. This allows a user to visually recognize various road signs clearly in night driving.

Since the ratio between the first and second fluorescent materials is merely an example, the present invention is not limited to the ratio.

### Example 2

The following describes another example of the light emitting part 5. As is the case with the Example 1, the present example employed the Caα-SiAlON fluorescent material and the CASN fluorescent material as the first and second fluorescent materials, respectively. However, in the present example, the light emitting part 5 having a diameter of 3 mm and a height of 5 mm was formed at the ratio 1:3.6:250 of the Caα-SiAlON fluorescent material, the CASN fluorescent material, and the silicon resin which serves as the sealing material. The light emitting part 5 was irradiated with laser beams having a wavelength of 405 nm, in order to measure a spectrum and a chromaticity of obtained illumination light.

As a result, the chromaticity of the illumination light was one indicated by coordinates of x=0.3102 and y=0.3189 in the graph of FIG. 4. The chromaticity satisfies the safety standard in Japan for road trucking vehicles. A color temperature of the illumination light was 6700 K. An average color rendering index Ra was 80.3. A special color rendering index R9 was 57.7. The Example 2 employs a higher ratio of the silicon resin which serves as the sealing material, and a lower ratio of the fluorescent materials, than those of the Example 1. It is considered that the lower density of the fluorescent materials resulted in a higher intensity of an excitation light component at 405 nm, so that the high color temperature was obtained.

FIG. 6 is a graph showing an emission spectrum of the light emitting part 5 of the present example. As shown in FIG. 6, this made it possible to obtain an emission spectrum which has a sufficiently high intensity near 510 nm which is the peak of luminosity factors in the scotopic vision. Further, the luminous intensity at the emission spectrum peak of the Caα-SiAlON fluorescent material which is the first fluorescent material is higher than the luminous intensities in the emission spectrum covering the range of not less than 540 nm but not more than 570 nm within which range the peak of luminosity factor in the photopic vision falls.

As compared to the Example 1, an intensity of the present example near 510 nm is relatively higher than the luminous intensities in the emission spectrum covering the range of not less than 540 nm but not more than 570 nm.

As a result, employment of the white light source of the present example as a vehicle headlamp makes it possible to realize a vehicle headlamp which excels in obstruction visibility in night driving.

The white light source in the Example 2 is not limited to one which is used in a completely dark place. That is, the white light source may be used in a light environment with dim light such as early evening.

(Modification)

The above deals with, as an example of the excitation light sources, only the laser diodes which emit laser beams at an oscillation wavelength of 405 nm. However, excitation light sources which can be employed in the present invention are not limited to this. For example, the excitation light sources may be conventional light emitting diodes which illuminate at nearly 450 nm. By employing the Caα-SiAlON:Ce³⁺ fluorescent material which has an emission peak near 510 nm, this also makes it possible to obtain a white light source which makes it possible to realize a vehicle headlamp having an improved obstruction visibility in the scotopic vision.

The reason why the Caα-SiAlON:Ce³⁺ fluorescent material has its emission peak in a range of not less than 500 nm but not more than 520 nm is that Ce³⁺ exists at a luminescence center. Therefore, any fluorescent material can be employed as the first fluorescent material instead of the Caα-SiAlON:Ce³⁺ fluorescent material, provided that the fluorescent material has Ce³⁺ at its luminescence center.

Further, the second fluorescent material may be Sr_{0.8}Ca_{0.2}AlSiN₃:Eu fluorescent material. The SrCaAlSiN₃:Eu (SCASN) fluorescent material has a high heat resistance. Therefore, the light emitting part is unlikely to become deteriorated even if the light emitting part is irradiated with a high-power excitation light at a high light density. Further, the SrCaAlSiN₃:Eu (SCASN) fluorescent material has its emission peak wavelength in a range of not less than 615 nm but not more than 630 nm. Further, the emission peak wavelengths thereof are 615 nm to 630 nm. Thus, the SCASN fluorescent material has its emission peak in a wavelength range which is further closer to the peak of the luminosity factor in the scotopic vision than the CASN fluorescent material having its emission peak in the wavelength range of not less than 620 nm but not more than 680 nm. This makes it possible to realize a vehicle headlamp which achieves a high scotopic visibility, a high luminance, and a high luminous flux.

Further, the first fluorescent material may be a semiconductor nanoparticle fluorescent material containing a III-V group compound semiconductor. In a case where the first fluorescent material is the semiconductor nanoparticle fluorescent material, a fluorescence wavelength varies according to a size of the nanoparticles. Therefore, in this case, the size of the nanoparticles is adjusted so that an emission peak falls within a range of not less than 500 nm but not more than 520 nm.

In a case where the nanoparticles have a uniform size, the semiconductor nanoparticle fluorescent material has a sharp peak of the emission spectrum. In a case where the nanoparticles have nonuniform sizes in contrast, the semiconductor nanoparticle fluorescent material has a gentle peak of the emission spectrum. Accordingly, by adjusting a size distribution of the nanoparticles in the semiconductor nanoparticle fluorescent material, it becomes possible to easily adjust the emission spectrum of the light emitting part 5.

Broadly speaking, there are two methods for adjusting sizes of the nanoparticles in the semiconductor nanoparticle fluorescent material. The semiconductor nanoparticle fluorescent material is produced by a chemical synthesis method. In one of the two methods for adjusting the sizes of the nanoparticles, a process parameter (e.g., temperature and/or time) in the chemical synthesis is changed so that a production size of the nanoparticles is adjusted.

The other method is to classify (screen), by size, the nanoparticles in the produced semiconductor nanoparticle fluorescent material. The first and second methods are actually combined so as to obtain the semiconductor nanoparticle fluorescent material having a desired particle size.

A size of the semiconductor nanoparticles having an emission peak in the range of not less than 500 nm but not more than 520 nm varies depending on a material for the semiconductor nanoparticle fluorescent material. For example, in a case where the semiconductor nanoparticle fluorescent material is InP, the size is not less than 1.7 nm but not more than 2.0 nm. In a case where the semiconductor nanoparticle fluorescent material is CdSe, the size is not less than 2.0 nm but not more than 2.2 nm.

Alternatively, the first and second fluorescent materials may be semiconductor nanoparticle fluorescent materials. In this case, two semiconductor nanoparticle fluorescent materials are mixed which have respective different nanoparticle sizes.

Alternatively, the first and second fluorescent materials may be an oxynitride fluorescent material and a semiconductor nanoparticle fluorescent material, respectively. The oxynitride fluorescent material and the semiconductor nanoparticle fluorescent material may be interchanged.

The present invention does not exclude, from its technical scope, employment of a light emitting part which contains a third fluorescent material in addition to the first and second fluorescent materials. What is important here is that: the first fluorescent material has its emission peak in the range of not less than 500 nm but not more than 520 nm; accordingly, an intensity in the emission spectrum of the illumination light is sufficiently high near 500 nm to 520 nm; and the intensity is not lower than intensities in other wavelength ranges. As long as the requirement is satisfied, fluorescent materials except the first fluorescent material and the sealing material may be varied in any way in type and ratio.

In a case where the white light source is realized as a vehicle headlamp, the fluorescent materials are adjusted in type and ratio so that, as described above, a white color is realized which satisfies the safety standard for road trucking vehicles.

(Effect of Headlamp 1)

As described above, application of the technical idea of the present invention to a vehicle headlamp makes it possible to realize the headlamp 1 which achieves an excellent visibility at least in the scotopic vision. Furthermore, the headlamp 1 makes it possible to obtain white light which satisfies safety standards in Japan etc., and which has a very high color rendering property.

The foregoing example is based on the safety standard in Japan for road trucking vehicles. A color of the illumination light of the headlamp 1 is adjusted in accordance with a rule stipulated in a country or a region (state or the like) in which the headlamp 1 is used.

### Embodiment 2

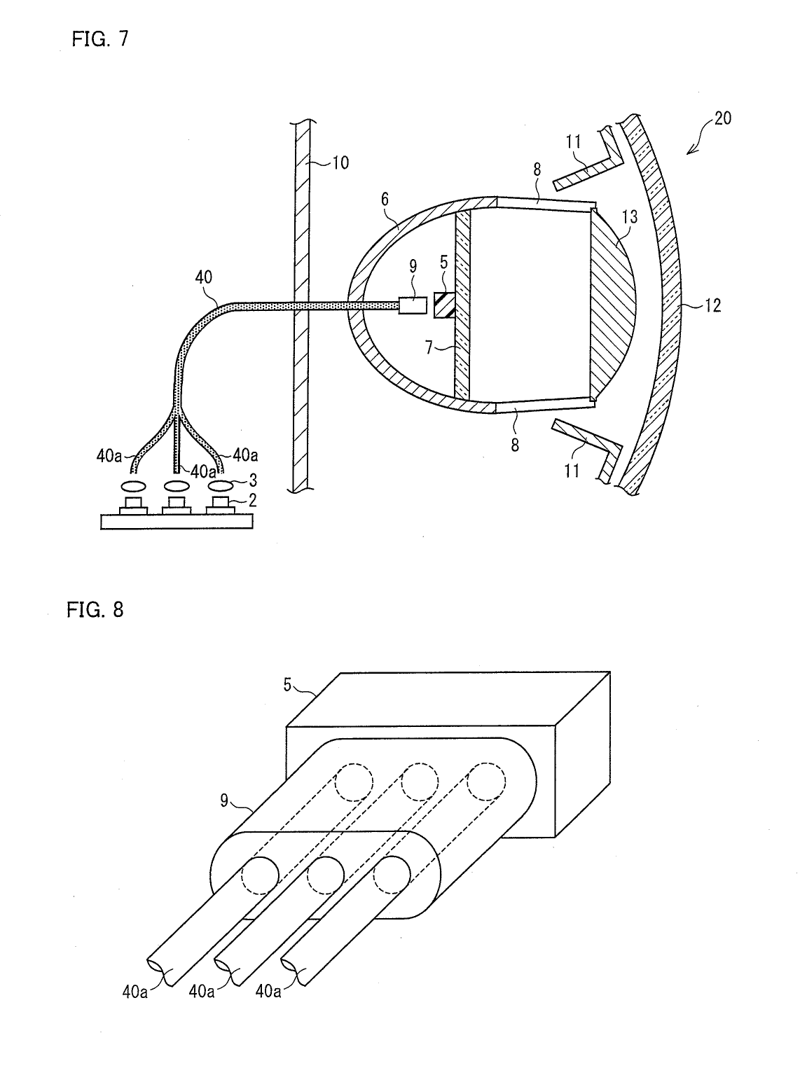

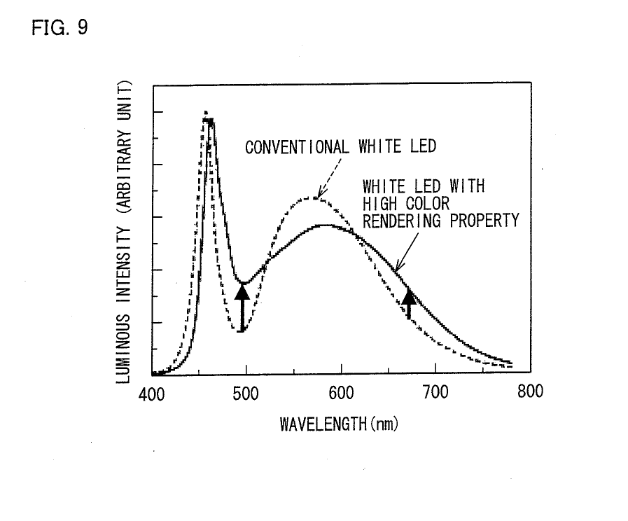

The following describes another embodiment of the present invention, with reference to FIG. 7. Members which are the same as those of the Embodiment 1 are given common reference signs, and descriptions of such members are not repeated. The present embodiment deals with a projector-type headlamp 20.

(Arrangement of Headlamp 20)

First, the following describes an arrangement of the headlamp 20 of the present embodiment, with reference to FIG. 7. FIG. 7 is a cross-sectional view illustrating an arrangement of the headlamp 20 which is a projector-type headlamp. The headlamp 20 is different from the headlamp 1 in that the headlamp 20 is a projector-type headlamp, and includes an optical fiber 40 instead of the light guide section 4.

As illustrated in FIG. 7, the headlamp 20 includes laser diodes 2, aspheric lenses 3, an optical fiber (light guide section) 40, a ferrule 9, a light emitting part 5, a reflection mirror 6, a transparent plate 7, a housing 10, an extension 11, a lens 12, a convex lens 13, and a lens holder 8. The laser diodes 2, the optical fiber 40, the ferrule 9, and the light emitting part 5 constitute a fundamental structure of a light emitting device.

The headlamp 20 is a projector-type headlamp, and therefore includes the convex lens 13. The present invention may be applied also to another type of headlamp, such as a semi-shield beam headlamp. In this case, the convex lens 13 may be omitted.

(Aspheric Lenses 3)

The aspheric lenses 3 are lenses for guiding laser beams (excitation light) emitted from the laser diodes 2 so that the laser beams enter the optical fiber 40 via light receiving ends each of which is one of two opposite ends of the optical fiber 40. The aspheric lenses 3 are provided as many as optical fibers 40a.

(Optical Fiber 40)

The optical fiber 40 is a light guide for guiding, to the light emitting part 5, the laser beams emitted from the laser diodes 2. The optical fiber 40 is a bundle of a plurality of optical fibers 40a. The optical fiber 40 has a double-layered structure, which consists of (i) a center core and (ii) a clad which surrounds the core and has a refractive index lower than that of the core. The core is made mainly of fused quartz (silicon oxide), which absorbs little laser beam and thus prevents a loss of the laser beam. The clad is made mainly of (a) fused quartz having a refractive index lower than that of the core or (b) synthetic resin material.

For example, the optical fiber 40 is made from quartz, and has a core of 200 μm in diameter, a clad of 240 μm in diameter, and numerical apertures (NA) of 0.22. Note however that a structure, diameter, and material of the optical fiber 40 are not limited to those described above. The optical fiber 40 can have a rectangular cross-sectioned surface, which is perpendicular to a longitudinal direction of the optical fiber 40.

The optical fiber 40 has a plurality of light-receiving ends for receiving the laser beams, and has a plurality of exit end parts for emitting the laser beams received via the plurality of light-receiving ends. As described later, the plurality of exit end parts are positioned by use of the ferrule 9 with respect to the laser beam-irradiated surface (light receiving surface) of the light emitting part 5.

(Ferrule 9)

FIG. 8 is a view illustrating positional relation between the exit end parts of the optical fibers 40a and the light emitting part 5. As illustrated in FIG. 8, the ferrule 9 holds, in a predetermined pattern, the plurality of exit end parts of the optical fibers 40a with respect to the laser beam-irradiated surface of the light emitting part 5. The ferrule 9 may have holes provided thereon in a predetermined pattern so as to accommodate the optical fibers 40a. Alternatively, the ferrule 9 can be separated into an upper part and a lower part, on each of which provided are bonding surface grooves for sandwiching and accommodating the optical fibers 40a.

A material for the ferrule 9 is not particularly limited. For example, the material is stainless steel. FIG. 8 shows three optical fibers 40a. However, the number thereof is not limited to three. The ferrule 9 is fixed by use of a member such as a bar-shaped member extended from the reflection mirror 6.

The positioning of the exit end parts of the optical fibers 40a by use of the ferrule 9 makes it possible to irradiate different parts on the light emitting part 5 with respective parts (highest-intensity parts) of the laser beams emitted from the plurality of optical fibers 40a which parts are the highest in intensity in respective light intensity distributions. The arrangement makes it possible to prevent a significant deterioration of the light emitting part 5 which is caused by convergence of the laser beams at one point. The exit end parts may have contact with the laser beam-irradiated surface, or may be positioned at small intervals.

It is not always necessary to position the exit end parts at intervals. A bundle of the optical fibers 40a may be positioned by use of the ferrule 9.

(Light Emitting Part 5)

The light emitting part 5 is the same as that of the Embodiment 1. The light emitting part 5 is provided in the vicinity of a first focal point (to be described later) of the reflection mirror 6. The light emitting part 5 may be fixed to an end of a tubular part that extends through a central portion of the reflection mirror 6.

(Reflection Mirror 6)

The reflection mirror 6 is, e.g., a member whose surface is coated with a metal thin film. The reflection mirror 6 reflects light emitted from the light emitting part 5, in such a way that the light is converged on a focal point of the reflection mirror 6. Since the headlamp 20a is a projector-type headlamp, a cross-sectional surface, of the reflection mirror 6, which is in parallel with a light axis of the light reflected by the reflection mirror 6 is basically in an elliptical shape. The reflection mirror 6 has the first focal point and a second focal point. The second focal point is closer to an opening of the reflection mirror 6 than the first focal point is. The convex lens 13 (to be described later) is provided so that its focal point is in the vicinity of the second focal point. Accordingly, the convex lens 13 projects, in a front direction, light converged by the reflection mirror 6 at the second focal point.

(Convex Lens 13)

The convex lens 13 converges the light emitted from the light emitting part 5 so as to project the converged light in the front direction from the headlamp 1. The convex lens 13 has its focal point in the vicinity of the second focal point of the reflection mirror 6. A light axis of the convex lens 13 extends through a substantially central portion of the light emitting surface of the light emitting part 5. The convex lens 13 is held by the lens holder 8, and is specified for its relative position with respect to the reflection mirror 6. The lens holder 8 may be formed as a part of the reflection mirror 6.

(Other Members)

The housing 10 defines a main body of the headlamp 20, and houses the reflection mirror 6 etc. The optical fiber penetrates the housing 10. The laser diodes 2 are provided outside the housing 10. Note here that the laser diodes 2 generate heat when emitting laser beams. In this regard, since the laser diodes 2 are provided outside the housing 10, the laser diodes 2 can be efficiently cooled down. Further, in consideration of a failure, it is preferable that the laser diodes 2 be provided in positions where they can be easily replaced. If there is no need to take these points into consideration, the laser diodes 2 can be housed in the housing 10.

The extension 11 is provided in an anterior portion of a side surface of the reflection mirror 6. The extension 11 hides an inner structure of the headlamp 20 so that the headlamp 20 looks better, and also strengthens connection between the reflection mirror 6 and a vehicle body. The extension 11 is a member whose surface is coated with a metal thin film, as is the case with the reflection mirror 6.

The lens 12 is provided on the opening of the housing 10, and seals the headlamp 20 therein. The light emitted from the light emitting part 5 travels in a front direction from the headlamp 1 through the lens 12.

As described above, the structure of the headlamp 1 may be varied in any wise. What is important for the present invention is that the light emitted from the light emitting part 5 sufficiently contains light which achieves a high visibility at least in the scotopic vision.

As described above, the illuminating device of the present invention is preferably arranged such that the first fluorescent material contains Ce³⁺ as its luminescence center.

According to the arrangement, the first fluorescent material containing Ce³⁺ as its luminescence center is employed as the first fluorescent material. This makes it possible to easily generate light which has its emission spectrum peak in the range of not less than 500 nm but not more than 520 nm, and which has a very broad emission spectrum covering a wavelength near the peak of the luminosity factor in the photopic vision.

This makes it possible to realize an illuminating device whose brightness cannot be felt by a user to be discontinuous in a case where a luminosity factor varies from early evening (photopic vision) in which dim light still remains to dark night (scotopic vision). Examples of the fluorescent material containing Ce³⁺ as its luminescence center encompass Caα-SiAlON:Ce³⁺ fluorescent material.

Further, the illuminating device of the present invention is preferably arranged such that the second fluorescent material has its emission spectrum peak in a range of not less than 600 nm but not more than 680 nm.

According to the arrangement, the fluorescence of the second fluorescent material has its emission spectrum peak in the range of not less than 600 nm but not more than 680 nm. Since the fluorescence of the first fluorescent material has its emission spectrum peak in the range of not less than 500 nm but not more than 520 nm, it is possible to easily adjust, within a range of white colors, a color of the light to be emitted from the light emitting part, by changing the ratio between the first and second fluorescent materials.

Further, the illuminating device of the present invention is preferably arranged such that the excitation light source emits excitation light having a wavelength of not less than 400 nm but not more than 420 nm.

By combining the first fluorescent material (emission peak wavelength is not less than 500 nm but not more than 520 nm) with the excitation light source for emitting excitation light having a wavelength in the range of not less than 400 nm but not more than 420 nm, it becomes possible to expand the range of options to choose a second fluorescent material which is required to realize an illuminating device having a light emitting part for emitting white light. Specifically, it becomes possible to employ, as the second fluorescent material, a fluorescent material having its emission spectrum peak in the range of not less than 600 nm but not more than 680 nm.

Further, the illuminating device of the present invention is preferably arranged such that the first fluorescent material is Caα-SiAlON (silicon aluminum oxynitride):Ce fluorescent material.

The Caα-SiAlON (silicon aluminum oxynitride):Ce fluorescent material has a high heat resistance. Therefore, according to the arrangement, the light emitting part is unlikely to become deteriorated even if the light emitting part is irradiated with a high-power excitation light at a high light density. This makes it possible to realize an illuminating device which achieves a high luminance and a high luminous flux.

Further, the illuminating device of the present invention is preferably arranged such that the first fluorescent material is a nanoparticle fluorescent material containing a III-V group compound semiconductor.

In a case where the nanoparticles have a uniform size, the semiconductor nanoparticle fluorescent material has a sharp peak of the emission spectrum. In a case where the nanoparticles have nonuniform sizes in contrast, the semiconductor nanoparticle fluorescent material has a gentle peak of the emission spectrum. Therefore, according to the arrangement, it becomes possible to easily adjust the emission spectrum of the light emitting part, by adjusting a size distribution of the nanoparticles in the first fluorescent material.

Further, the illuminating device of the present invention is preferably arranged such that the second fluorescent material is CaAlSiN₃:Eu fluorescent material.

The CaAlSiN₃:Eu (CASN) fluorescent material has a high heat resistance. Therefore, according to the arrangement, the light emitting part is unlikely to become deteriorated even if the light emitting part is irradiated with a high-power excitation light at a high light density. This makes it possible to realize an illuminating device which achieves a high luminance and a high luminous flux.

Further, the illuminating device of the present invention is preferably arranged such that the second fluorescent material is Sr_{0.8}Ca_{0.2}AlSiN₃:Eu fluorescent material.

The SrCaAlSiN₃:Eu (SCASN) fluorescent material has a high heat resistance. Therefore, according to the arrangement, the light emitting part is unlikely to become deteriorated even if the light emitting part is irradiated with a high-power excitation light at a high light density. Furthermore, the SrCaAlSiN₃:Eu (SCASN) fluorescent material has its emission peak wavelength in a range of not less than 615 but not more than 630 nm. The emission peak wavelength is further close to the peak of the luminosity factor in the scotopic vision. This makes it possible to realize an illuminating device which achieves a high visibility in the scotopic vision, a high luminance, and a high luminous flux.

Further, a vehicle headlamp of the present invention includes the illuminating device, a color of light which is emitted from the light emitting part being a white color which falls within a legally-stipulated range of colors of light of vehicle headlamps.

In countries such as Japan and the US, it is required by law to employ, as a color of light of a vehicle headlamp, a white color having a chromaticity in a predetermined range.

According to the arrangement, the second fluorescent material has an emission spectrum peak which is different from that of the first fluorescent material; and a fluorescence color of the second fluorescent material and the ratio between the first and second fluorescent materials in the light emitting part are adjusted so that a fluorescence color of light which is emitted from the light emitting part when the light emitting part is irradiated with the excitation light is a white color which falls within the range of colors of light of vehicle headlamps which range is legally stipulated in a country or a region (state or the like) in which the vehicle headlamp is used.

This makes it possible to generate light which has its emission spectrum peak in the range of not less than 500 nm but not more than 520 nm, and which has a chromaticity in the legally-stipulated range. In addition, it is possible to realize a vehicle headlamp having an improved visibility at least in the scotopic vision.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present invention is applicable to an illuminating device and a headlamp which are used in a case where it is necessary to improve visibility of an object (particularly in a dark place), particularly to a vehicle headlamp.

### REFERENCE SIGNS LIST

1 Headlamp (illuminating device, vehicle headlamp)
2 Laser diode (excitation light source)
5 Light emitting part
20 Headlamp

1. An illuminating device comprising:
an excitation light source that emits excitation light; and
a light emitting part that emits light upon receiving the excitation light emitted from the excitation light source, the light emitting part containing a first fluorescent material and a second fluorescent material, the first fluorescent material having its emission spectrum peak in a range of not less than 500 nm but not more than 520 nm, the second fluorescent material having an emission spectrum peak which is different from the emission spectrum peak of the first fluorescent material,
in a spectrum of the light emitted from the light emitting part, a luminous intensity at the emission spectrum peak of the first fluorescent material being higher than a luminous intensity in an emission spectrum covering a range of not less than 540 nm but not more than 570 nm.

2. The illuminating device as set forth in claim 1, wherein the first fluorescent material contains Ce³⁺ as its luminescence center.

3. The illuminating device as set forth in claim 1, wherein the second fluorescent material has its emission spectrum peak in a range of not less than 600 nm but not more than 680 nm.

4. The illuminating device as set forth in claim 1, wherein the excitation light source emits excitation light having a wavelength of not less than 400 nm but not more than 420 nm.

5. The illuminating device as set forth in claim 1, wherein the first fluorescent material is Caα-SiAlON (silicon aluminum oxynitride):Ce fluorescent material.

6. The illuminating device as set forth in claim 1, wherein the first fluorescent material is a nanoparticle fluorescent material containing a III-V group compound semiconductor.

7. The illuminating device as set forth in claim 1, wherein the second fluorescent material is CaAlSiN₃:Eu fluorescent material.

8. The illuminating device as set forth in claim 1, wherein the second fluorescent material is Sr_{0.8}Ca_{0.2}AlSiN₃:Eu fluorescent material.

9. A vehicle headlamp comprising an illuminating device recited in claim 1, a color of light which is emitted from the light emitting part being a white color which falls within a legally-stipulated range of colors of light of vehicle headlamps.
